(19) United States
(12) Patent Application Publication
(10) Pub. No.: US 2002/0134119 A1
(43) Pub. Date: Sep. 26, 2002

(54) Physical security device and method for portable device

(76) Inventor: Jay S. Derman, Palo Verdes Pensinsula, CA (US)

Correspondence Address: Michael E. Woods, McCutchen, Doyle, Brown & Enersen, Suite 1800, Three Embarcadero, San Francisco, CA, 94111-4067, US

(21) Appl. No.: 09/813,924

(22) Filed: Mar. 20, 2001

(51) Int. Cl. E05B 69/00

(52) U.S. Cl. 70/58

(57) ABSTRACT

A locking system for a portable device. Most preferably, the device includes a generally rectilinear housing portion having a first and a second generally planar side. The system includes a first flexible line forming a first bight; a second flexible line forming a second bight; a junction of the bights positioned proximate the first side of the housing such that the bights engage diagonally opposite comers of the housing portion; a coupler, engaging the bights and positioned proximate the second side of the housing, for joining the bights together to maintain the bights over the diagonally opposite comers of the housing; and a localizer, coupled to the coupler, for constraining movement of the housing.

### FIELD OF THE INVENTION

The invention relates generally to theft-deterrent devices, and more specifically to a system for deterring unauthorized use and movement of a portable device.

### BACKGROUND OF THE INVENTION

Many portable devices such as, for example, laptop computers and other portable electronic devices are manufactured having a portion of a housing wall provided with a specially designed security slot. Specifications for this slot have been promulgated by the assignee of the present invention as a standard. This standard may be found at Kensington's web page at http:/Hwww.kensington.com/developers/dev_{—}11 99.html, and is hereby expressly incorporated by reference for all purposes.

It is well-known to provide physical locking devices designed to interface to this specially designed security slot. An exemplary product is the Kensington MICROSAVER® physical security product, as well as other preferred embodiments embodied in several issued including U.S Pat. Nos. 5,327,752, issued Jul. 12, 1994—entitled “Computer Equipment Lock”; 5,381,685, issued Jan. 17, 1995—entitled “Computer Physical Security Device”; 6,000,251, issued Dec. 14, 1999—entitled “Computer Physical Security Device”; 5,502,989, issued Apr. 2, 1996—entitled “Computer Physical Security Device”; 5,493,878, issued Feb. 27, 1996—entitled “Computer Physical Security Device”; 6,155,088, issued Dec. 5, 2000—entitled “Computer Physical Security Device”; 6,000,252, issued Dec. 14, 1999—entitled “Computer Physical Security Device”; 6,112,562, issued Sep. 5, 2000—entitled “Computer Physical Security Device”; 6,006,557, issued Dec. 28, 1999—entitled “Computer Physical Security Device”; 6,112,561, issued Sep. 5, 2000—entitled “Security Device for a Portable Computer”; 5,787,739, issued Aug. 4, 1998—entitled “Security Hole Fastening Device”; 6,038,891, issued Mar. 21, 2000—entitled “Security Hole Fastening Device” and U.S. patent application Ser. Nos. 09/426,066, filed Oct. 22, 1999—entitled “Cable Locking Device”; 60/128,988, filed Apr. 12, 1999—entitled “Security Hole Fastening Device” and 09/532,382, filed Mar. 22, 2000—entitled “Slot Adapter” for example, all hereby expressly incorporated by reference for all purposes.

These products are effective at deterring unauthorized movement of the portable device to which it is secured by localizing the portable device to a relatively immoveable object. The materials of the lock are designed so that the housing must be damaged in order to separate the lock from the portable device. By this expedient, unauthorized movement of the portable device is inhibited for several reasons. These reasons include a reluctance of a party to be observed damaging the housing as it would be obvious to observers that such party was unauthorized to tamper with the portable device. In addition, successfully separating the lock from the portable device in this fashion creates a damaged housing near the defeated security slot that is difficult, if not impossible, to repair, evidencing unauthorized possession of the portable device.

As successful as these prior art locks are, they are unable to provide protection when the portable device lacks a security slot. The prior art provides for a retrofit slot adapter that is typically adhered to a wall of a housing, but such solutions are not always desirable.

Another drawback in some instances is that while the lock deters unauthorized movement, it does not always inhibit unauthorized use of the portable device while it is secured by the lock.

### SUMMARY OF THE INVENTION

The present invention provides for a simple, efficient solution to some of the disadvantages of the prior art. The locking system and method of the present invention not only provide for a theft-deterrence for portable devices, but it also provides for a solution that is effective in deterring unauthorized use of certain portable devices, including devices such as laptop computers or personal digital assistants (PDAs) that have hinged members that are separated in order to operate the device. Closing these members and securing the locking system by use of the claimed method will secure the electronic device with the hinged members in the closed position, deterring operation of the electronic device.

A preferred embodiment of the present invention includes a locking system for a portable device. Most preferably, the device includes a generally rectilinear housing portion having a first and a second generally planar side. The system includes a first flexible line forming a first bight; a second flexible line forming a second bight; a junction of the bights positioned proximate the first side of the housing such that the bights engage diagonally opposite corners of the housing portion; a coupler, engaging the bights and positioned proximate the second side of the housing, for joining the bights together to maintain the bights over the diagonally opposite corners of the housing; and a localizer, coupled to the coupler, for constraining movement of the housing.

An alternate preferred embodiment of the present invention includes a method for securing a portable device. Most preferably, the device includes a generally rectilinear housing portion having a first and a second generally planar side. The method includes securing a first bight of a first flexible line to a first corner of the housing portion; securing a second bight of a second flexible line, sharing a junction with the first flexible line, to a second corner, diagonally opposite from the first corner, of the housing such the junction is proximate the first side of the housing; securing the bights together on the second side of the housing to form a harness around the housing; and localizing the harness to a first area to inhibit movement of the portable device outside of the area.

Further understanding of the nature and advantages of the invention may be realized by reference to the remaining portions of the specification and drawings. In the drawings, similarly numbered items represent the same or functionally equivalent structures.

### BRIEF DESCRIPTION OF THE DRAWINGS

FIG. 1 is a perspective plan view of a preferred embodiment of the present invention;

FIG. 2 is a rear plan view of the preferred embodiment illustrated in FIG. 1;

FIG. 3 is a front plan view of an alternate preferred embodiment of the present invention;

FIG. 4 is a view of a first preferred embodiment for a flexible line that may be used in the present invention;

FIG. 5 is a view of the first preferred embodiment having the flexible line twisted to produce two bights;

FIG. 6 is a view of a second preferred embodiment for a flexible line system producing two bights that may be used in the present invention; and

FIG. 7 is a view of a third preferred embodiment for a flexible line system producing two bights that may be used in the present invention.

### DESCRIPTION OF THE SPECIFIC EMBODIMENTS

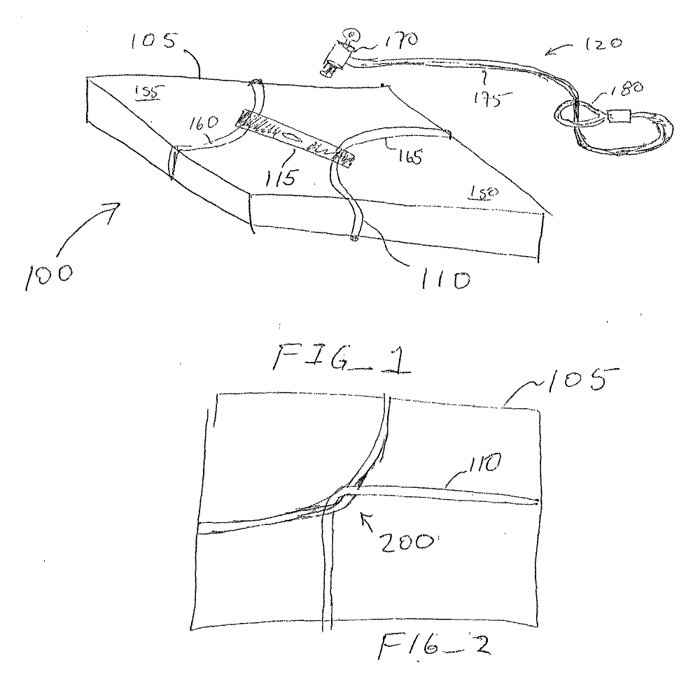

FIG. 1 is a perspective plan view of a preferred embodiment of the present invention. A locking system 100 for a portable device 105 includes a harness 110, a coupler 115 and a localizer 120. Portable device 105 includes such structures as laptop computers, personal digital assistants (PDAs), or other high-value, easily carried structures, such as those that may fit into a backpack, carrying case or pocket, for example. Portable device 105 is shown as a rectilinear structure, but the present invention may be used on other types of structures. Device 105 includes a first corner 150 and a diagonally-opposite second corner 155. The present invention will work in conjunction with structures offering a similar relationship among protuberances that project generally opposite each other, such as the comers for example.

Harness 110 is made of a flexible line, such as a cable or chain or other structure, including multifilament or multiline structures, having a strong tensile strength that may be shaped or bent to conform to portable device 105. The degree to which the flexible line resists separation, severing, or stretching relates directly to the effectiveness of the flexible line for use in the present invention. Harness 110 may be formed of one or more flexible lines that singly, or in combination with other flexible lines, produce a first bight 160 and a second bight 165 (or loops). Harness 110 is sized to have bight 160 engage corner 150 and bight 165 engage corner 155 to be able to be drawn taut by use of coupler 115. Depending upon the adjustability of coupler 115, harness 110 may be adapted for many different sizes and configurations of portable device 105.

Coupler 115 simply joins bight 160 to bight 165 after the bights have engaged the corners. Generally, coupler 115 is positioned near a center or a centroid of a first generally side of portable device 105. Coupler 115 may be made of almost any material, as long as it too has a high tensile strength and resists separation, severing or stretching. Coupler 115 may have many different configurations to achieve its function of joining and holding the two bights together. In the preferred embodiment, coupler 115 also provides a structure for coupling with localizer 120.

In this preferred embodiment, coupler 115 includes a security slot conforming to the Kensington Technology Group's security standard referenced and incorporated above. The slot is generally a through-hole having dimensions of about 7 mm×3 mm.

Localizer 120 of the preferred embodiment is a Kensington MICROSAVER® computer physical security product, or other computer physical security products such as those described in the incorporated patent applications. Localizer 120 includes an attachment head 170 for engagement with coupler 115, a flexible line 175 having a predetermined length, and terminating in a loop 180. Loop 180 is used to form flexible line 175 around an object (not shown) other than an element of locking system 100. Forming loop 180 in this fashion constrains movement of portable device 105 to within a distance from the object about equal to the predetermined length of flexible line 175.

Localizer 120 may have alternate constructions, depending upon a specific application and other design considerations. For example, flexible line 175 may be integrated into coupler 115, or include a second loop instead of head 170 for attachment to coupler 115. In some applications, localizer 120 may be an embedded trigger-device, such as a magnetic strip, or other tag such as those used in conventional inventory control systems. For this type of localizer 120, movement of portable device 105 is constrained by the tag sensors/actuators located at key exits or entrances. In some applications, localizer 120 may not be coupled directly to coupler 115, but rather to harness 110 or to a cable rider provided on one of the flexible lines as provided in U.S. patent application Ser. No. 09/426,066, filed Oct. 22, 1999, entitled Cable Locking Device (hereby expressly incorporated by reference for all purposes), or directly to a security slot provided as part of portable device 105.

FIG. 2 is a rear plan view of the preferred embodiment illustrated in FIG. 1. Harness 110 is illustrated in which the flexible lines are joined at a junction 200. Junction 200 is preferably positioned near a center or a centroid of second planar side of the portable device 105. In this preferred embodiment, harness 110 is composed of two discrete flexible lines having the ends of each line joined together to form two discrete loops. The two loops are intertwined when constructed and attach to each other at junction 200. As described below, harness 110 may have other configurations, and is not limited to this embodiment.

In operation, junction 200 is positioned near a center of the second planar side of portable device 105 such that bight 160 engages corner 150 and bight 165 engages diagonally opposite corner 155. Coupler 115 engages bight 160 and bight 165 and draws the flexible lines taut about portable device 105 to form harness 110. Flexible line 175 is passed around a relatively immoveable object unconnected to portable device 105 and head 170 is passed through loop 180 to engage localizer 120 with the immoveable object. Head 170 engages coupler 115 to secure harness 110 to localizer 120 to thereby maintain portable device 105 (captured within harness 110) within a predetermined distance of the immoveable object. In the case where portable device 105 is a laptop computer having a hinged member (e.g., screen) overlying a body portion (e.g., keyboard/CPU), the engagement of harness 110 about portable device 105 when it is closed provides additional security by inhibiting use of the device in addition to inhibiting movement of the device. In certain configurations, harness 110 may be designed for use with a particular portable device 105 such that harness 110 may be adapted to interfere with access to various input/output (1/0) ports or media access apertures (floppy disk or CDROM) to further control access to resources of portable device 105.

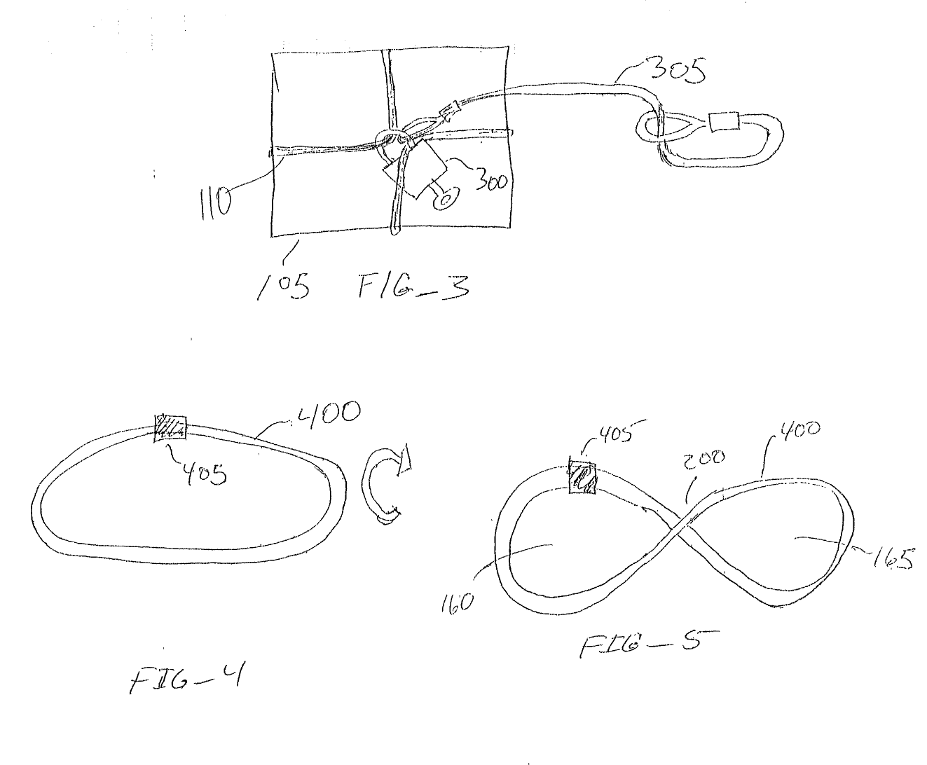

FIG. 3 is a front plan view of an alternate preferred embodiment of the present invention illustrating use of a padlock 300 as coupler 115 to interconnect harness 110 with a modified localizer 305. Padlock 300 interconnects bight 160, bight 165 and a loop of localizer 305. By this expedient, harness 110 is formed around portable device 105 and is connected to localizer 305 at the same time.

FIG. 4 is a view of a first preferred embodiment for a flexible line 400 that may be used in the present invention. Flexible line 400 includes a connector 405 designed to secure the two ends of line 400 together to form a single, inextensible closed loop.

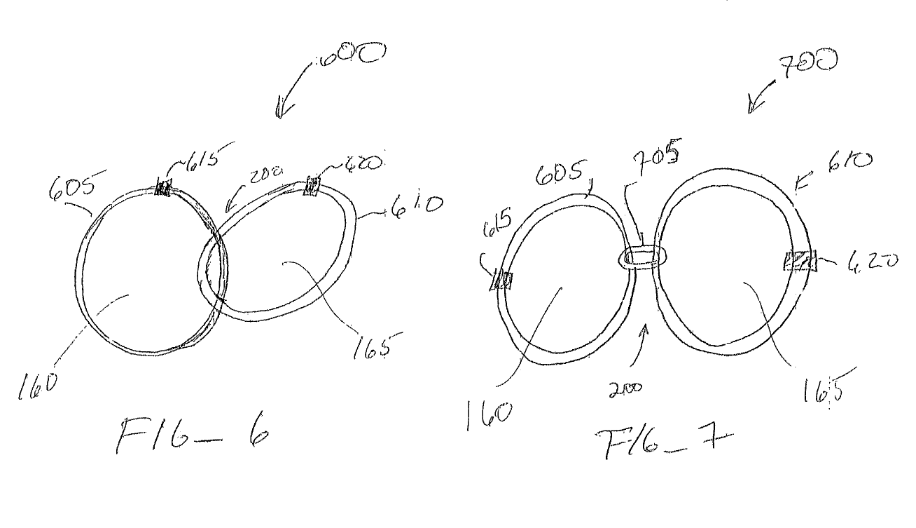

FIG. 5 is a view of the first preferred embodiment shown in FIG. 4 having flexible line 400 twisted to produce two loops. Twisting flexible line 400 about itself 180 degrees or more results in formation of first bight 160, second bight 165 and junction 200. The twisted flexible line 400 may be used to form harness 110 as described above.

FIG. 6 is a view of a second preferred embodiment for a flexible line system 600 producing two bights that may be used in the present invention. Line system 600 includes a first flexible line 605 and a second flexible line 610. The ends of each flexible line (605 and 610) are each joined together by a connector 615 and 620, respectively, to form two single, inextensible closed loops each similar to that shown in FIG. 4. Line 605 interlocks with line 610 prior to production of junction 200 where the two lines are joined. Flexible line system 600 may be used to form harness 110 as described above, with line 605 forming loop 160 and line 610 forming loop 165.

FIG. 7 is a view of a third preferred embodiment for a flexible line system 700 producing two bights that may be used in the present invention. Line system 700 includes a first flexible line 605 and a second flexible line 610. The ends of each flexible line (605 and 610) are each joined together by a connector 615 and 620, respectively, to form two single, inextensible closed loops each similar to that shown in FIG. 4. A joining coupler 705 interlocks line 605 with line 610 prior to production of junction 200 where the two lines are joined. Flexible line system 700 may be used to form harness 110 as described above, with line or other connecting structure 605 forming loop 160 and line 610 forming loop 165. Joining coupler 705 is a ring having similar design considerations for coupler 115 except that coupler 705 need not be removable from one or more flexible lines making up harness 110. Joining coupler 705 may, in certain applications, have small amounts of elasticity or play. Locking system 700 permits each flexible line to lie relatively flat in a plane while locking system 600 has one portion of a flexible line overlying a portion of another flexible line.

In the foregoing specification, the invention has been described with reference to specific exemplary embodiments thereof. It will, however, be evident that various modifications and changes may be made therewith without departing from the broader spirit and scope of the invention as set forth in the claims.

Many changes or modifications are readily envisioned, for example, changing the harness or couplers to further envelope the portable device, among other possible changes. The specification and drawings are, accordingly to be projected in an illustrative rather than in a restrictive sense.

What is claimed is:

1. A locking system for a portable device including a generally rectilinear housing portion having a first and a second generally planar side, comprising:
a first flexible line forming a first bight;
a second flexible line forming a second bight;
a junction of said bights positioned proximate the first side of the housing such that said bights engage diagonally opposite comers of the housing portion;
a coupler, engaging said bights and positioned proximate the second side of the housing, for joining said bights together to maintain said bights over said diagonally opposite comers of the housing; and
a localizer, coupled to said coupler, for constraining movement of said housing.

2. A locking system, comprising:
a portable rectilinear housing having a first generally planar side and a second generally planar side;
a first flexible line forming a first bight;
a second flexible line forming a second bight;
a junction of said bights positioned proximate said first side such that said bights engage diagonally opposite comers of said housing;
a coupler, engaging said bights and positioned proximate said second side, for joining said bights together to maintain said bights over said diagonally opposite corners of said housing; and
a localizer, coupled to said coupler, for constraining movement of said housing.

3. A locking system, comprising:
a portable rectilinear housing having a first generally planar side and a second generally planar side;
a flexible line having a first end coupled to a second end to produce a loop, a first portion of said loop rotated approximately one hundred eighty degrees relative to a second portion to form a first bight and a second bight meeting at a junction, said junction positioned generally proximate a centroid of said first side and said bights engaging diagonally opposite comers of said housing;
a coupler, coupled to said bights and positioned generally proximate a centroid of said second side, for joining said bights together to maintain said loop surrounding said housing; and
a localizer, coupled to said coupler, for constraining movement of said housing.

4. A locking system, comprising:
a portable rectilinear housing having a first generally planar side and a second generally planar side;
a first flexible line having a first end coupled to a second end to produce a first loop;
a second flexible line having a first end coupled to a second end to produce a second loop;
a first coupler, coupled to said first and second loops, said first coupler positioned generally proximate a centroid of said first side such that said loops engage diagonally opposite comers of said housing;
a second coupler, coupled to said loops and positioned generally proximate a centroid of said second side, for joining said loops together to maintain said loops surrounding said housing; and
a localizer, coupled to said coupler, for constraining movement of said housing.

5. A method for securing a portable device including a generally rectilinear housing portion having a first and a second generally planar side, comprising:
securing a first bight of a first flexible line to a first corner of the housing portion;
securing a second bight of a second flexible line, sharing a junction with said first flexible line, to a second corner, diagonally opposite from said first corner, of the housing such said junction is proximate the first side of the housing;
securing said bights together on the second side of the housing to form a harness around said housing; and
localizing said harness to a first area to inhibit movement of the portable device outside of said area.
